(19) United States
(12) Patent Application Publication
(10) Pub. No.: US 2006/0162574 A1
(43) Pub. Date: Jul. 27, 2006

(54) Modified grill top cooking tool with radiused end caps

(76) Inventor: Peter F. Prip, Cranston, RI (US)

Correspondence Address: CRISTINA M. OFFENBERG, 494 BROADWAY, NEWPORT, RI, 02840, US

(21) Appl. No.: 11/038,222

(22) Filed: Jan. 21, 2005

(51) Int. Cl. A47J 37/07

(52) U.S. Cl. 99/450

(57) ABSTRACT

A novel grill top cooking tool is provided that contains and cooks food on a grill surface. The modified grilling tool is comprised of a main body with removable end caps that are secured to either edge of the main body. An attaching device allows for connection of a detachable tool to place the modified grilling tool on a hot surface and for turning the modified grilling tool during the cooking process and removing the modified grilling tool when finished cooking.

### FIELD OF INVENTION

The present invention relates generally to grilling tools.

### BACKGROUND OF THE INVENTION

This invention relates to grilling cooking tools and the accompanying hardware. The term cooking tool as used herein is intended to define a device used in preparing and cooking of food and, particularly, one for use on a grilling surface.

Grill top cooking has been in existence for a very long time and many devices have been invented to aid a cook in cooking on a grill as it differs from cooking on a frying pan, electric skillet or stove top. This cooking tool functions in a way that contains and cooks food on a grill surface. It was invented to allow a chef or home cook a new way to enjoy grilled foods.

Grilling has become an incredibly popular way to cook foods. However, as with all cooking methods, there are limitations to the process. An uneven heat source and foods that do not all lie flat on the grill, make grill cooking a difficult thing to achieve with consistency. Flavorings applied externally to foods (e.g. spices, herb marinades) can easily burn off on a grill. The subject invention is a modification to a tool that provides a new way of cooking on the grill and addressing these problems. The subject invention is a self contained enclosed modified grilling tool that allows for balanced heat distribution having removable top and bottom caps that are radiused and allow for food loading and unloading convenience. In order to use the tool, meats, fish or poultry are cut into strips or pieces allowing for more surface area to be coated and for the meat, fish, or poultry to be more easily molded into the subject cooking tool. The meat, fish or poultry can then be layered into the cooking tool offering interesting entrees that offer a variety of color, texture, and a blending of flavors. Any food such as vegetables or herbs may be layered with the main course and cooked together.

### SUMMARY OF THE INVENTION

The present invention responds to the problems presented and addresses changes made to the original grill top cooking tool. This modification to the grill top cooking tool has a solid main body made of resilient material, having end caps with radiused grates placed on both the top and bottom of the main body. The approximate diameter of the tool is three and three-quarters (3¾) inches by two (two) inches high in the preferred embodiment other shapes could also be used to cook food but round would be preferred embodiment. Both the height and diameter can be increased or decreased depending on the type of cooking that needs to be done. The height of the main body of the preferred embodiment described in the drawings is sufficiently high to allow for vegetables placed in the center of the tool to be cooked al dente. A thinner version of the tool with more surface area, i.e. a larger diameter, would allow for more of the food to be directly exposed to the coals of the grill.

Many grilled foods are traditionally bathed or soaked in a marinade first. These marinades are often acidic in nature and usually contain lemon juice or a vinegar source, therefore, the interior surface of the tool that is exposed to the food can stick to the end caps of the grilling tool during the cooking process and thus it is found that making a radius in the end caps prevents this problem. The preferred embodiment is constructed of a ten thousandths thickness of a non-reactive metal such as porcelain enamel or stainless steel. The thickness described is used in the preferred embodiment but may also be changed to suit the needs of the user. The stainless steel which is exposed to the food is non-reactive to acid and, therefore, safe to use with any food product and conducts heat sufficiently to cook the food. Cast iron is another possible metal. Thin gauge stainless steel will work but it is not as efficient as the more conductive metals. Each of these possible choices is associated with different costs and, therefore, there could be two possible lines of the product: one low-end, low cost version for the back yard grilling cook and another high-end, high cost model for the professional chef. The top and bottom end caps are constructed of similar materials as the main section. It should be noted that the top and bottom also serve to conduct heat to food contained within the tool.

The subject invention is a round or oval metal ring that has two radiused end caps which are removable. The first end cap is put in place prior to layering food into the tool by hooking a protruding aperture or slot on the end cap onto a protruding flange from the main body of the modified grilling tool. In order to use the tool, meats, fish or poultry are cut into strips or pieces allowing for more surface area to be cooked and for meat, fish, or poultry to be more easily molded into the subject cooking tool. The meat, fish or poultry can then be layered into the cooking tool with a different vegetable, herbs, or other food thereby producing meals with a variety of color, texture, and blending of flavors. The containment of the foods in this modified grilling tool assures a more moist and flavorful result. The radiused end caps have slots or perforations in them allow for the penetration of smoke and drainage of juices. The radius in the end caps allows the cooked food to be removed from the modified grilling tool with ease. In prior experiences, the cooked food would adhere to the slots or perforations of the end caps and need to be prodded off with a utensil and would damage the look of the end product. With the radius of the end caps, the food shrinks away from the end caps when cooked and allows the user to easily remove the food from the container when cooking is completed. After the cooking is complete, the end caps are removed to allow for the easy removal of the food package.

There are many uses for this tool in the grilling industry. There is no limitation as to the type of foods that can be grilled in this tool. Foods that are not traditionally grilled (such as fruit, polenta, or legumes) or too small to grill on traditional grill top can now be grilled in the subject invention.

Another feature of the modified grilling tool is the detachable gripping device which allows for a cook or chef to place the modified grilling tool onto a hot surface and to turn over the tool so both sides are in contact with the grilling surface. Grill space in restaurants and even in back yards is often at a premium. A gripping device that attaches when the tool is being placed on the grill and during the flipping of the tool and then detached when the food is cooking leaves extra grill space available. The modified grilling tool could be flipped over with a spatula, however, food contamination is a concern with a spatula that has first come into contact with raw meats, fish and poultry and then into contact with cooked food. The detachable gripping device is a safe way to avoid contamination and allows for secure manipulation of grilling tools.

The invention provides a novel cooking tool that provides a new way of grilling food including the following novel features: 1) a tool that provides a food product that may easily be removed after grilling; 2) a tool that is easy and inexpensive to manufacture; 3) the containment of the foods allows for cooking foods that are traditionally difficult to cook on a grill; 4) a presentation of the food that is aesthetically pleasing; 5) a modified grilling tool that provides efficient use of grill space. All other novel features which are believed to be characteristic of the invention are set forth in the appended claims. It is believed the invention will be best understood by reference to the following description take in connection with the accompanying drawings.

### BRIEF DESCRIPTION OF THE DRAWINGS

FIG. 1 is a perspective view of the modified grilling tool.

FIG. 2 is a view of the exterior side of a radiused end cap

FIG. 3 is a view of the interior side of a radiused end cap

FIG. 4 is a cross section of FIG. 3 showing te depth of the holes

FIG. 5 is a circular main body of the modified grilling tool

FIG. 6 is the bracket for the detachable handle

FIG. 7 is a partial view of the device with a cut away section showing the retaining clips are flush with surface of end cap

FIG. 8 is a plain view showing the clip mechanism

FIG. 9 is a close up view of the bracket for the detachable handle

### DETAILED DESCRIPTION OF THE DRAWINGS

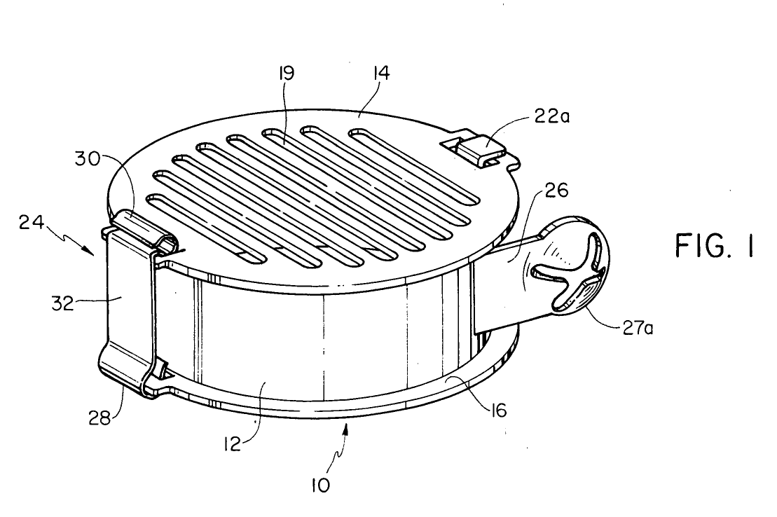

In all the drawings, like elements are labeled with the same reference numbers. FIG. 1, illustrates the modified grilling tool 10 with the solid main body 12 shown as circular. The first radiused end cap 14 is placed adjacent to the top edge of the solid main body 12 and the second radiused end cap 16 is placed adjacent to the bottom edge of the solid main body 12. The first radiused end cap 14 and second radiused end cap 16 are secured to the main body on one side by way of a protruding flanges 22a and 22b located on the top and bottom sides of the detachable handle bracket. The radiused end caps are secured into place after the food is loaded by a clip locking device 24. The detachable handle bracket 26 is permanently secured to one side of the solid main body 12. The detachable handle bracket 26 allows for a detachable handle (not shown in FIG. 1) to be placed within the first and second handle keepers 27a, 27b so the modified grilling tool can be place onto a hot surface and turned over during cooking to prevent the user from burning one's hand.

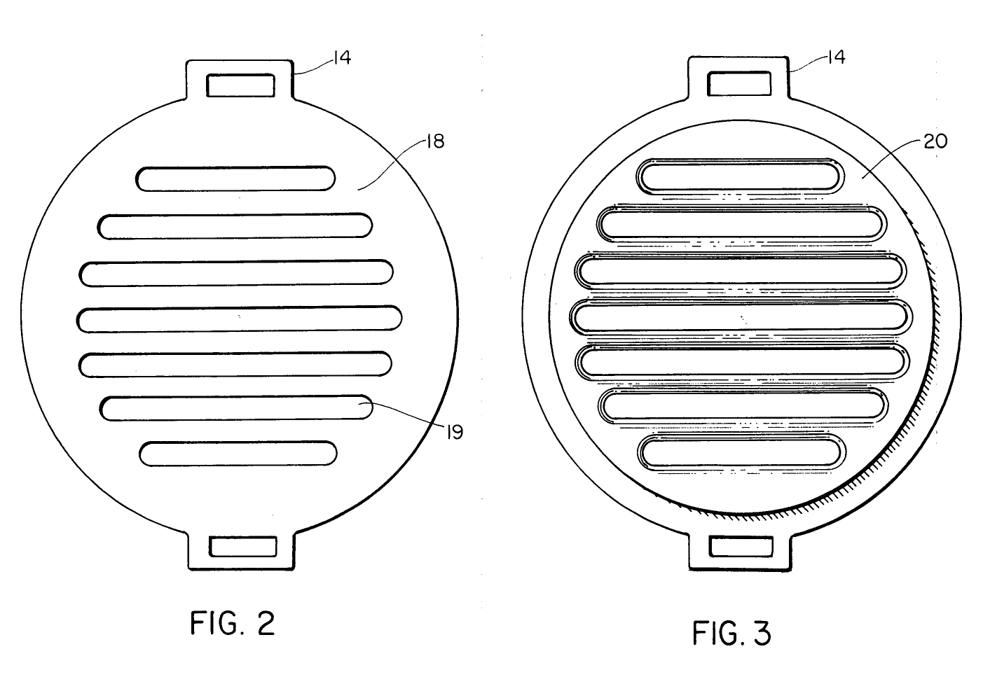

FIGS. 2 and 3 show the exterior side 18 and interior side 20 of the first radiused end cap 14. The exterior side 18 is a smooth surface end cap that is adapted to fit the entire diameter of the solid main body 12 having a smooth surface which comes into contact with the grilling surface. The interior side of the end caps is radiused to allow for easy removal after the food is cooked as the food shrinks away from the radiused end caps. This eliminates the need to have the interior surface of the end caps to be coated with a second material for easy removal of food. The radiused end cap has cut into the cap a plurality of slots or perforations 19 to allow for the smoke from the grill to reach the food within the modified grilling tool 10, and to provide juices to be released. The slots or perforations 19 also provide a grilling effect to the food product.

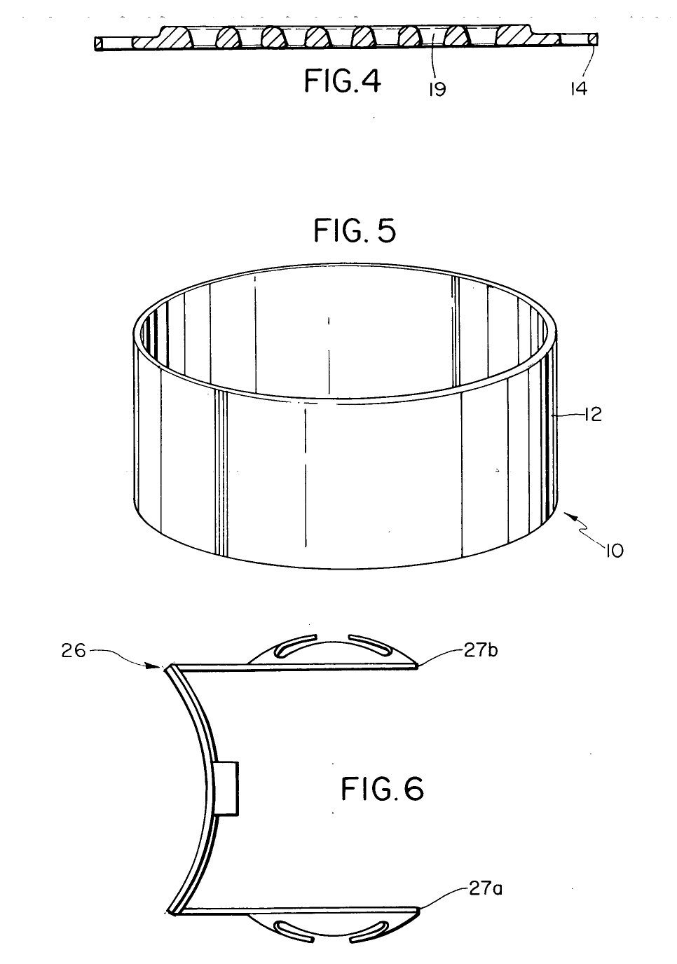

FIG. 4, illustrates a cross section of one of the end caps 14 showing the plurality of slots or perforations cut into the depth of the end cap 14.

FIG. 5 is a front view of the solid main body 12 of the modified grilling tool 10. The solid main body 12 is annular and comprised of a solid material that is non-reactive metal.

FIG. 6 is a top view of the detachable handle bracket 26 which is a holding means for the detachable handle (not shown). The detachable handle bracket 26 is permanently fixed to the side of the modified grilling tool by way of rivets. A detachable handle is designed to easily fit within the detachable handle keepers 27a and 27b to pick up or turn the modified grilling tool. The user can then place the modified grilling tool onto the hot surface and then release the gripping tool from the keepers 27a and 27b and remove the detachable handle during cooking. When the food is ready to be turned over, the user reattaches the detachable handle to the keepers and flips over the modified grilling tool 10 or removes it from the hot surface.

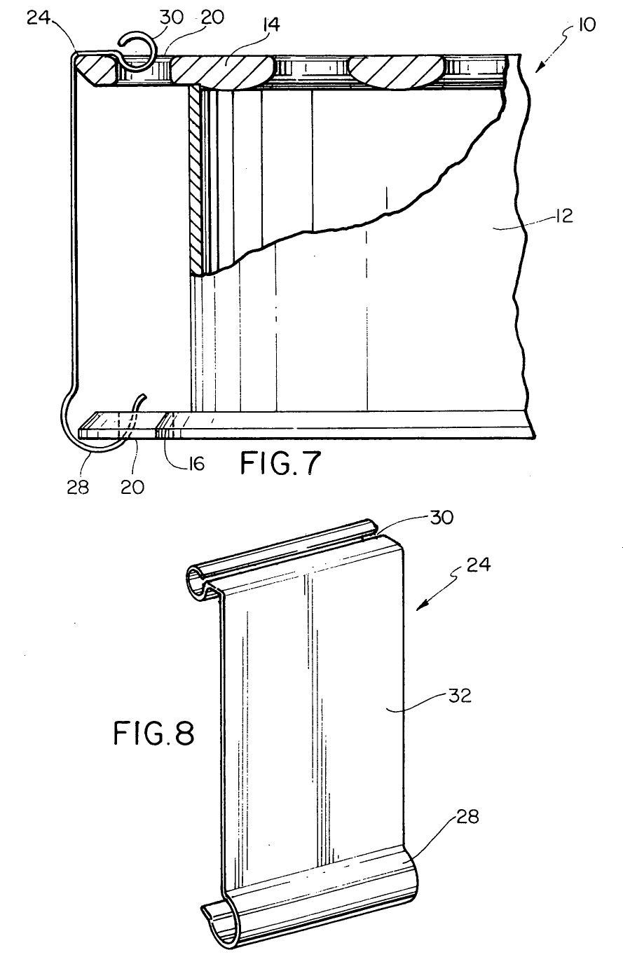

FIG. 7 is a partial view of the modified grilling tool with a cut away showing the clip locking device 24 holding in place the first end cap 14 and the second end cap 16. The bottom “U” member 28 of the clip locking device 24 is hooked under the exterior side 20 of the second end cap 16. The top “C” member 30 of the clip locking device 24 is snapped onto the exterior side 20 of the first end cap 14.

FIG. 8 shows the clip locking device 24 is a one piece clip has a bottom “U” member 28, a flat middle section 32 and a top “C” member 30 wherein the bottom “U” member 28 fits on the second end cap, the flat middle section 32 lies flush against the exterior wall of the solid main body 12 and the top “C” member clamps onto the second end cap 16 to hold the modified grilling too 10 together during cooking.

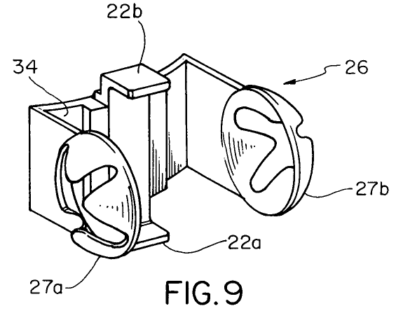

FIG. 9 illustrates the detachable handle bracket 26 apart from the main body 12. The detachable handle bracket 26 has a flat back member 34. There are two detachable handle keepers 27a and 27b protruding from the sides of the flat back member which are attachment points for the detachable handle. On the top and bottom of the flat back member are protruding flanges 22a and 22b which hold the first end cap 14 and second end cap 16 in place prior to the clip locking device 24 being snapped on to the modified grilling tool 10.

What is claimed is:

1. a solid main body of resilient material having a top edge, a bottom edge, an inner surface and an outer surface;
a first radiused end cap having an interior surface placed adjacent to the top edge of the main body and having a protruding first aperture on a first edge and a second protruding aperture opposite the first aperture;
a second radiused end cap having an interior surface placed adjacent to the bottom edge of the main body and having a first protruding aperture on a first edge and a second protruding aperture opposite the first aperture;
wherein said first protruding apertures of the end caps are adapted to be fitted with protruding flanges from the outer surface of the main body;
a clip locking device having a first end which is U shaped and adapted to slide into the second aperture of the second end cap and a second end which is C shaped and adapted to snap into the second aperture of the first end cap thereby holding the second end cap onto the bottom edge of the main body and holding the first end cap onto the top edge of the main body.

2. A modified grilling tool as claimed in claim 1 further comprising a detachable handle bracket attached to the outer surface of the main body having a flat back member attached flush to the main body and having two outwardly projecting handle keeps spaced apart from each other adapted to accept a detachable handle.
